(19) United States
(12) Patent Application Publication
(10) Pub. No.: US 2007/0124487 A1
(43) Pub. Date: May 31, 2007

(54) DNS server

(75) Inventors: Tetsuro Yoshimoto, Kokubunji (JP); Toru Matsukawa, Yamato (JP)

Correspondence Address: Stanley P. Fisher;Reed Smith LLP, Suite 1400, 3110 Fairview Park Drive, Falls Church, VA, 22042-4503, US

(73) Assignee: Hitachi Communication Technologies, Ltd.

(21) Appl. No.: 11/494,486

(22) Filed: Jul. 28, 2006

(30) Foreign Application Priority Data
Nov. 28, 2005 (JP) 2005-341725

(51) Int. Cl. G06F 15/16

(52) U.S. Cl. 709/230

(57) ABSTRACT

Even if a mistaken reply to a host name resolution request of IPv6 is issued by a DNS contents server, a requesting terminal can still acquire an IPv4 address. When a host name resolution request of IPv6 (AAAA query) is received, a DNS proxy server generates a host name resolution request of IPv4 having an identical domain name, transmits this together with the AAAA query to the DNS contents server, and determines the DNS reply which should be returned to the terminal from the contents of the DNS reply of IPv6 (AAAA reply) and the DNS reply (A reply) of IPv4 received from the DNS contents server. Hence, even if a reply message showing a domain name error is received from the DNS contents server, if the A reply is correct, the DNS proxy server generates an AAAA reply showing that the desired address does not exist, and returns this to the terminal.

### CLAIM OF PRIORITY

The present application claims priority from Japanese application JP 2005-341725 filed on Nov. 28, 2005, the content of which is hereby incorporated by reference into this application.

### FIELD OF THE INVENTION

The present invention relates to a DNS server, and in particular, relates to a DNS proxy server which receives a host name resolution request from a terminal, and accesses a DNS contents server.

### BACKGROUND OF THE INVENTION

IP (Internet Protocol) networks make extensive use of DNS (Domain Name System) in order to acquire the domain name of a communication partner device and its corresponding IP address. DNS is used with combinations of two types of servers. One is a server which has a correspondence table between domain names and IP addresses, and returns an IP address in response to a host name resolution request. This server is referred to as a DNS contents server or authorization DNS server. The other is a server which receives a host name resolution request from a terminal, and forwards this host name resolution request to another suitable server. This is referred to as a DNS proxy server or DNS cache server.

In the Internet which forwards packets according to IP addresses, there are plural DNS contents servers which manage the IP addresses of domains having different IP addresses. These DNS contents servers have a tree structure, and form hierarchical databases. In general, each DNS contents server is installed by a body which manages domain names.

DNS proxy servers and DNS cache servers, on the other hand, look up a specific DNS contents server having an enquiry domain name specified by a host name resolution request from a DNS contents server tree on behalf of a terminal, and transmit the host name resolution request to this specific DNS contents server. When a DNS reply message which contains a target IP address is received from the DNS contents server, this server forwards it to the requesting terminal.

The DNS cache server has a cache memory which stores a correspondence relation between domain names and IP addresses, and if there is a target IP address requested by the host name resolution request in the cache memory, this is returned to the requesting terminal. DNS proxy servers and DNS cache servers are often installed by organizations such as carriers who provide direct IP network access services to terminals. Normally, the DNS server specified by the terminal means a DNS proxy server or DNS cache server. In the following specification, the DNS cache server and DNS proxy server are represented by a DNS proxy server.

However, an IP network has a “IPv4/v6 dual stack” system wherein an IPv4 protocol or IPv6 protocol having different address architectures, can be used selectively. Each terminal which belongs to a IPv4/v6 dual stack system, when acquiring the IP address of a communication partner device, generally issues an IPv6 host name resolution request message (hereafter, “AAAA query”) prior to an IPv4 host name resolution request message (hereafter, “A query”). When a reply message stating that an IPv6 address is not assigned to a specified host name is received in response to an AAAA query, the requesting terminal issues an A query to acquire an IPv4 address corresponding to the specified host name. In other words, in the IPv4/v6 dual stack method, IPv6 addresses and IPv4 addresses can be used selectively according to the situation,

In RFC 4074 (Common Misbehavior Against DNS Queries for IPv6 Addresses), it has been pointed out that the problem of applying the IPv4/v6 dual stack method to a network is that the DNS contents server may take the wrong action with respect to an AAAA query which specified a host name without an IPv6 address. As a result, the target IP address fails to be acquired, or a lengthy delay occurs in IP network access processing up to the requesting terminal.

Specifically, if the AAAA query is disregarded by the DNS contents server, in the requesting terminal which is waiting for a reply, an A query cannot be issued until the predetermined latency time times out, so access processing of the IP network is very much delayed. Moreover, if the DNS contents server, in reply to the AAAA query, erroneously returns a DNS reply message (hereafter, NXDOMAIN) showing that the enquiry domain name specified by the AAAA query does not exist in the Internet, when it should reply that “IPv6 address data (AAAA data) does not exist in the enquiry domain name”, IP network access processing is stopped by the requesting terminal when NXDOMAIN is received. In this case, since the requesting terminal cannot acquire the IPv4 address by an A query either, communication with the partner device becomes completely impossible.

This kind of problem should be essentially solved on the DNS contents server side which processes the host name resolution request, but the Internet consists of decentralized management bodies with mutually independent DNS contents servers, and it is virtually impossible to force all of these management bodies to resolve this problem. As one way of avoiding this kind of problem, in Chapter 3 of IPv6 Fix (http://v6fix.net/docs/v6fix.html.ja, Chapter 3), it has therefore been proposed to reconstruct the software on the terminal side.

### SUMMARY OF THE INVENTION

However, most terminals used by Internet users have Proprietary Software such as Windows, so it is often difficult for a terminal user to implement the aforesaid solution which requires reconstruction of the terminal software.

It is therefore an object of the present invention to provide a DNS proxy server such that a user terminal can acquire an IPv4 address without modifying the software of the user terminal, even when a DNS contents server issues an erroneous reply message in response to an AAAA query.

It is a further object of the invention to provide a DNS proxy server which can shorten the reply latency time to an AAAA query in a terminal.

The present invention was conceived so that most of the DNS contents servers in the Internet could provide a correct response to a host name resolution request message of IPv4 (A query). When a host name resolution request message of IPv6 (AAAA query) is received from a terminal, a DNS proxy server generates an A query having an identical enquiry host name to that of the AAAA query as a probe, which is then transmitted to the DNS contents server together with the AAAA query. The DNS proxy server of the invention also determines a DNS reply message of IPv6 to be returned to the terminal from the contents of the DNS reply message of IPv6 (AAAA reply) and the DNS reply message of IPv4 (A reply) received from the DNS contents server.

Describing this in more detail, the DNS proxy server of the invention includes a request processor which, when a DNS enquiry message AAAA request of IPv6 is received from a terminal, generates a DNS enquiry message A request of IPv4 with the same enquiry domain name as the enquiry message, and transmits the AAAA request and A request to a specific DNS contents server in the Internet. It further includes a reply processor which, when NXDOMAIN showing that the enquiry domain name is an error, is received as the DNS reply message of IPv6 to the AAAA request from the DNS contents server, generates a different DNS reply message from NXDOMAIN according to the details of the DNS reply message of IPv4 to the A request received from the DNS contents server, and transmits it to the terminal.

Describing this in still more detail, in the DNS proxy server of the invention, even if NXDOMAIN is received as the DNS reply message of IPv6, and a normal A reply showing an IPv4 address corresponding to the enquiry domain name is received as the DNS reply message of IPv4, the aforesaid reply processor generates a message AAAA reply showing that there is no IPv6 address in the enquiry domain name, and transmits it to the requesting terminal.

For example, if NXDOMAIN is received prior to the DNS reply message of IPv4 from the DNS contents server, in the DNS proxy server of the invention, the reply processor waits for reception of the DNS reply message of IPv4 from the DNS contents server while retaining NXDOMAIN. In one embodiment of the invention, when NXDOMAIN is received, the reply processor starts a timer for restricting the latency time of the DNS reply message of IPv4, and if this timer times out without receiving a DNS reply message of IPv4, it transmits NXDOMAIN to the requesting terminal when timeout occurs.

In a preferred embodiment of the invention, when an AAAA request or A request is transmitted, the request processor of the DNS proxy server starts a timer for measuring the reply time of the DNS contents server, and if NXDOMAIN is received first, the reply processor determines the latency time of the DNS reply message of IPv4 according to the reply time shown by the aforesaid measurement timer. If the aforesaid reply time measurement timer reaches a predetermined timeout time without receiving either a DNS reply message of IPv6 or a DNS reply message of IPv4 from the DNS contents server, the reply processor of the DNS proxy server generates NXDOMAIN showing that the enquiry domain name of the AAAA request is an error as the DNS reply message of IPv6, and transmits it to the requesting terminal.

For example, if an A reply is received prior to the DNS reply message of IPv6 from the DNS contents server, the reply processor of the DNS proxy server starts a timer for restricting the latency time of the DNS reply message of IPv6, and if NXDOMAIN is received before this timer times out, it generates a message AAAA reply showing that there is no IPv6 address in the enquiry domain name, and transmits it to the requesting terminal.

If the aforesaid timer times out without receiving a DNS reply message of IPv6, the reply generates the message AAAA reply showing that there is no IPv6 address in the enquiry domain name, and transmits it to the requesting terminal. The latency time of the DNS reply message of IPv6 can also be determined according to the reply time shown by the reply time measurement timer of the DNS contents server.

If the reply time measurement timer reaches a predetermined timeout time without receiving either a DNS reply message of IPv6 or a DNS reply message of IPv4 from the DNS contents server, the reply processor of the DNS proxy server generates, as the DNS reply message of IPv6, NXDOMAIN showing that the enquiry domain name of the AAAA request is an error, and transmits it to the requesting terminal.

If a normal AAAA reply showing an IPv6 address corresponding to the enquiry domain name is received as the DNS reply message of IPv6 corresponding to the AAAA request from the DNS contents server, the reply processor of the DNS contents server transmits this AAAA reply to the requesting terminal.

If the DNS proxy server of the invention is a DNS cache server having a cache memory which stores the relation between the enquiry domain name and IP address shown by the AAAA reply and A reply received from the DNS contents server, when an AAAA request or A request is received from the terminal, and the request processor looks up the cache memory, if there is an IP address corresponding to the enquiry domain name shown by the received request in the cache memory, it generates a DNS reply message showing this IP address, and transmits it to the requesting terminal.

According to the invention, the misbehavior of a DNS contents server can thus be dealt with without modifying the software of a user terminal which uses an IPv4/V6 dual stack. Also, if the invention is applied to a DNS cache server, the DNS cache server can acquire an IPv4 address from the DNS contents server in advance by forwarding an A request when an AAAA request is forwarded, so if an A query is received from a terminal, the IPv4 address read from the cache memory can rapidly be returned.

### BRIEF DESCRIPTION OF THE DRAWINGS

FIG. 1 is a schematic diagram of a network construction to which the DNS proxy server of the invention is applied;

FIG. 2 is a first example of a communications sequence showing the functions of the DNS proxy server of the invention;

FIG. 3 is a second example of a communications sequence showing the functions of the DNS proxy server of the invention;

FIG. 4 is a third example of a communications sequence showing the functions of the DNS proxy server of the invention;

FIG. 5 is a fourth example of a communications sequence showing the functions of the DNS proxy server of the invention;

FIG. 6 is a diagram showing a packet format of a DNS message;

FIG. 7 is a diagram showing a message format of an AAAA query issued by a terminal;

FIG. 8 is a diagram showing a message format of an A query generated by a DNS proxy server;

FIG. 9 is a diagram showing a message format of an AAAA reply issued by a DNS contents server;

FIG. 10 is a diagram showing a message format of an AAAA reply generated by a DNS contents server;

FIG. 11 is a diagram showing the construction of a DNS proxy server;

FIG. 12 is a diagram showing an example of a query management table 16 with which a DNS proxy server is provided;

FIG. 13A is a flow chart showing part of an AAAA query processing routine 200 executed by the DNS proxy server; and

FIG. 13B is a flow chart showing the remaining part of the AAAA query processing routine 200.

### DETAILED DESCRIPTION OF THE PREFERRED EMBODIMENTS

The invention will now be described in more detail referring to specific embodiments.

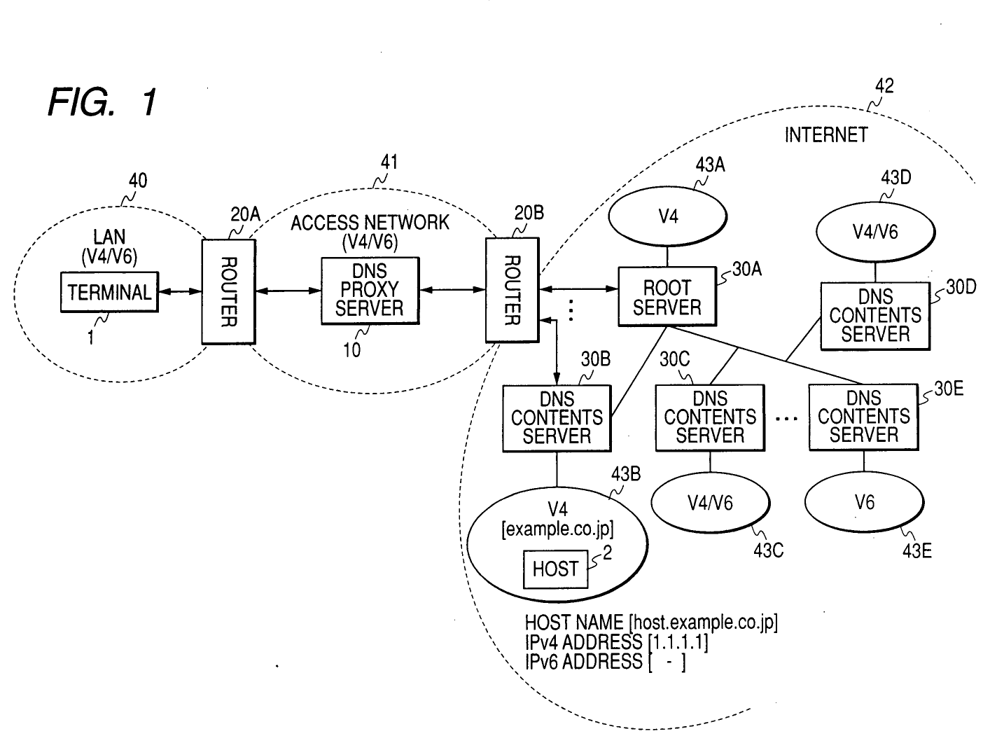

FIG. 1 is a schematic diagram showing a network in which the DNS proxy server of the invention is applied. Here, 40 is an IPv4/V6 dual stack-compatible LAN to which a user terminal 1 belongs, and 41 is an IPv4/V6 dual stack-compatible access network to which a DNS proxy server 10 belongs. The DNS proxy server 10 is connected to the LAN 40 via a boundary router 20 A, and is connected to the Internet 42 via another boundary router 20 B. More specifically, the access network 41 is a company infrastructure network or a provider network, and the terminal 1 communicates with a host device (server, or other computer) in the Internet 42 via the DNS proxy server 10 of a provider with whom a contract has previously been made.

The Internet 42 is actually a conglomeration of plural domains 43 (43A, 43B, 43C, . . . ) which are managed by various management bodies. In FIG. 1, the domain networks 43A, 43B are IPv4 address networks, the domain networks 43C, 43D are IPv4/IPv6 dual address networks, and the domain network 43E is an IPv6 address network. There are separate DNS contents servers 30 (30A, 30B, 30C, . . . ) for each management body, and each DNS contents server 30 stores a correspondence relation between host names and IP addresses in the domain network 43 under management control in a management table.

The plural DNS contents servers 30 in the Internet 42 are systematically organized so as to form a DNS tree. The DNS proxy server 10 can resolve the IP addresses of all the host names on the Internet by performing a search starting from the uppermost contents server 30A known as the root server.

Suppose a server which misbehaves in response to an AAAA query, which was a problem in the prior art, is for example the contents server 30B which manages the domain network 43B in which only IPv4 addresses can be applied. The DNS contents server 30B, for example in regard to a host 2 in the domain network 43B, stores a correspondence relation between a host name “host.example.co.jp” and an IPv4 address “1.1.1.1”, but does not retain the IPv6 address of the host 2.

In FIG. 1, for convenience, the DNS proxy server 10 is shown as an independent server, but the functions of the DNS proxy server 10 may also be implemented by the boundary router 20A or 20B. Also, the DNS proxy server 10 is not necessarily installed in the access network 41, but may be installed anywhere inside a range in which communication with the terminal 1 and DNS contents server 30 is possible. The terminal 1, when the DNS contents server is accessed, may also go through a DNS server other than the DNS proxy server 10.

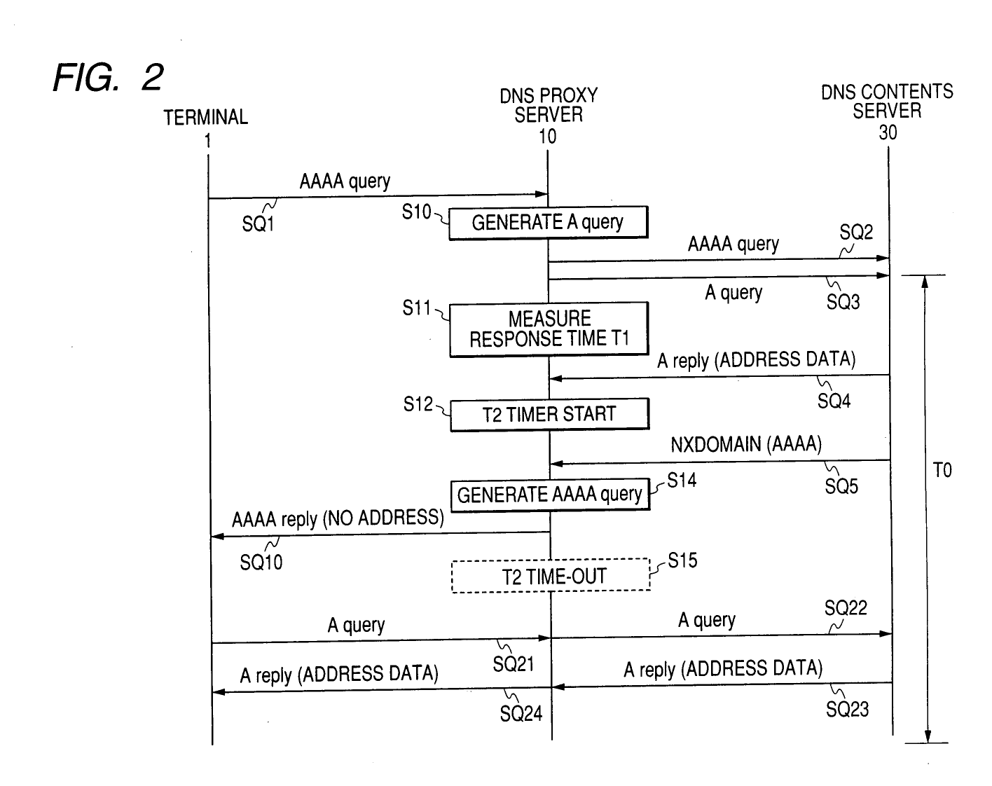

FIG. 2 shows a first example of a communication sequence showing the functions of the DNS proxy server 10 of the invention.

When the terminal 1 which belongs to the IPv4/IPv6 dual stack network 40, acquires the IP address of a specific host which is a communications partner in the Internet 42, it transmits a host name resolution request message of IPv6 (an AAAA query) to the DNS proxy server 10 before a host name resolution request message of IPv4 (A query) (SQ1). As described later, the AAAA query has a header part and an enquiry part, and includes a specific host name (enquiry host name) whose address is to be resolved in the enquiry part.

The essential feature of the invention is that the DNS proxy server 10 which received the aforesaid AAAA query automatically generates an A query having an identical enquiry host name from the received AAAA query, and transmits the AAAA query and A query at approximately the same time to the DNS contents server 30 (e.g., 30B) (SQ2, SQ3). The DNS proxy server which received these queries then starts measuring a predetermined time (reply time) T1 until the first reply is received from the DNS contents server 30 (S11).

In actual application, the DNS proxy server 10 performs processing such as a DNS tree search to specify the DNS contents server 30 (e.g., 30B) to which the queries are addressed, prior to transmitting these queries (SQ2, SQ3), but since these processing sequences are normally executed by a DNS proxy server anyway, they are omitted from FIG. 2 for simplicity.

If the DNS proxy server 10 is a DNS cache server having a cache function, when the AAAA query is received, it searches an IPv6 address corresponding to the enquiry host name from a cache memory. If the desired IP address exists, it then forwards a DNS reply message itself to the requesting terminal 1 without forwarding the AAAA query to the DNS contents server. In the case of a DNS cache server, the communication sequence described below corresponds to the communication sequence when the desired IPv6 address does not exist in the cache memory.

Here, a sequence is shown wherein the DNS contents server 30 replies to the A query, and after returning an A reply showing an IPv4 address corresponding to the enquiry host name (SQ4), it returns NXDOMAIN (AAAA) showing that the enquiry host name does not exist in the Internet (SQ5).

When the DNS proxy server 10 receives the A reply from the DNS contents server 30, it starts a T2 timer (S12), and waits for an IPv6 DNS reply message from the DNS contents server corresponding to the AAAA query. The T2 timer is intended to restrict the latency time of the IPv6 DNS reply message, and times out when a time T2 has elapsed from the start.

The value of the timeout period T2 may be a fixed value, but may also be computed by a first order relation (T2=α.T1) previously set up according to the value of the time T1 from when the AAAA query or A query is transmitted to when the first reply (A reply) is received. The coefficient α may be any desired value having an integer part and a decimal part.

Here, assume that NXDOMAIN (AAAA) returned by the DNS contents server 30 arrives at the DNS proxy server 10 before the T2 timer times out (S15). In this case, NXDOMAIN (AAAA) conflicts with the A reply which has already been received, so the DNS proxy server 10 determines that the DNS contents server 30 has mistakenly issued NXDOMAIN (AAAA). Hence, the DNS proxy server 10 generates an AAAA reply (No address) showing that an IPv6 address does not exist in the specified host name based on the contents of the received NXDOMAIN (S14), and transmits it to the requesting terminal 1 (SQ10).

The terminal 1 which received the aforesaid AAAA reply (No address) determines that an IPv6 address cannot be applied to the specified host which is a communications partner, and transmits a host name resolution request message A query of IPv4 in order to acquire an IPv4 address (SQ21).

When the DNS proxy server 10 receives the aforesaid A query, this is forwarded to the DNS contents server 30 (SQ22) The DNS contents server 30 returns an A reply showing the IPv4 address corresponding to the specified host name as the reply to the received A query (SQ23). The DNS proxy server 10 then forwards the A reply to the terminal 1 (SQ24).

Due to the aforesaid communication sequence, the terminal 1 can apply an IPv4 address to the communication with the host which is the communications partner, without interrupting connection to the Internet due to NXDOMAIN which was mistakenly issued by the DNS contents server 30.

If the DNS proxy server 10 is a cache server, the DNS proxy server 10, by storing the contents of the A reply received from the DNS contents server 30 in the step SQ4 in a cache memory, can transmit the A reply to the terminal 1 when it receives the A query from the terminal 1 (SQ21) omitting the steps SQ22, SQ23.

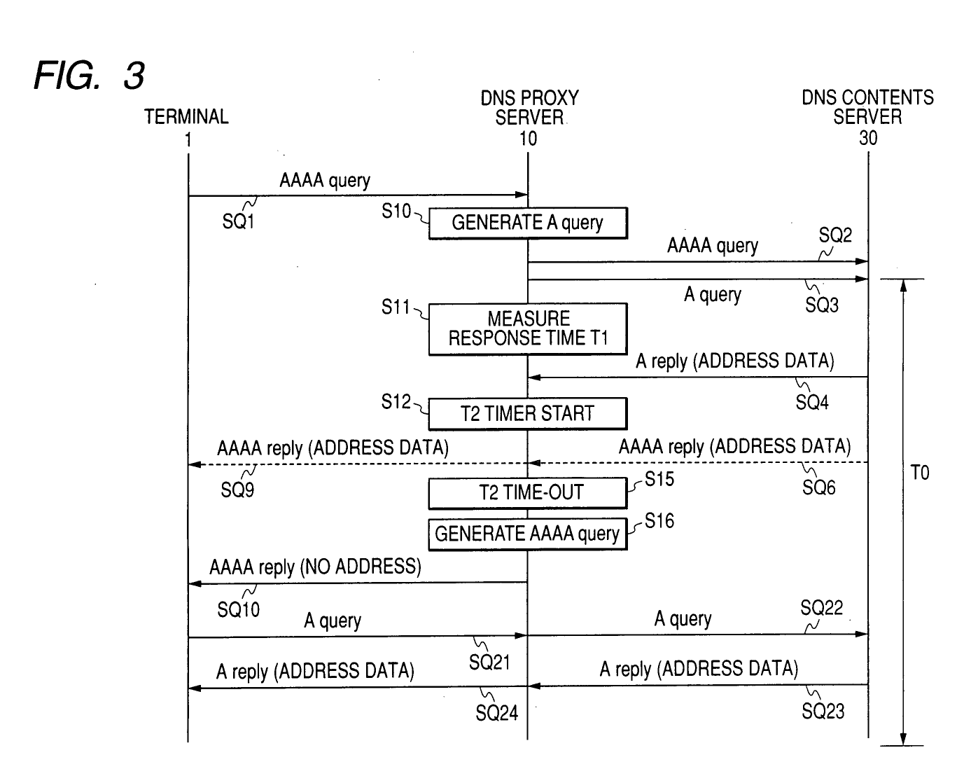

FIG. 3 shows a communications sequence when, after the DNS proxy server 10 receives the A reply (SQ4) in the sequence of FIG. 2, the T2 timer times out (S15) while waiting for a reply to the AAAA query.

The DNS proxy server 10, by receiving the A reply (SQ4), has verified that the host name (domain) specified by the AAAA query does exist in the Internet. Hence, when the T2 timer has timed out (S15), the DNS proxy server 10 generates an AAAA reply (No address) specifying that an IPv6 address does not exist in the specified host name based on the contents of the aforesaid reply (S16), and transmits it to the requesting terminal 1 (SQ10). The sequence thereafter is identical to that of FIG. 2.

Hence, by having the DNS proxy server 10 issue an AAAA reply (No address) at T2 timeout, an A query can be transmitted to the requesting terminal 1 with a shorter latency time than the prior art timeout period T0 set to restrict the reply latency time to an AAAA query (SQ21), and communication between the terminal 1 and the host can start earlier. In particular, if the DNS proxy server 10 is a cache server, the A reply can be returned immediately from the DNS proxy server 10 in response to the A query (SQ24), so communication between the terminal 1 and the host can be started even earlier.

As shown by the dotted line, if the DNS contents server 30 returns a normal reply message AAAA reply (address data) showing an IPv6 address corresponding to the host name before T2 times out (SQ6), the DNS proxy server 10 forwards the received AAAA reply to the requesting terminal 1. In this case, the terminal 1 starts communicating with the host immediately applying the IPv6 address shown by the AAAA reply.

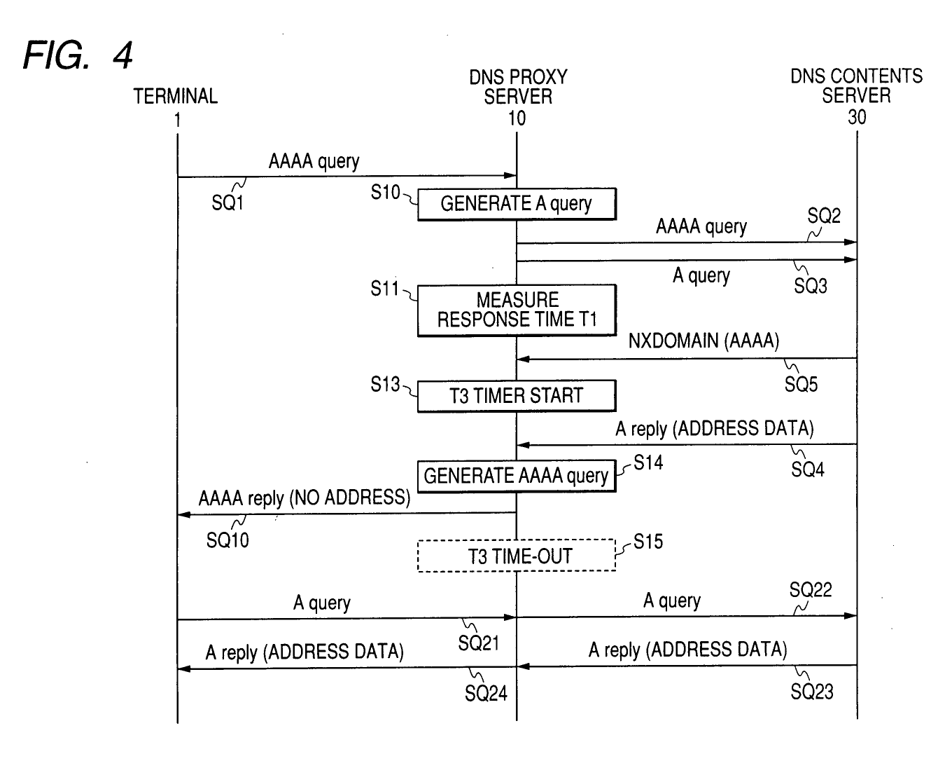

FIG. 4 shows a communication sequence where the DNS contents server 30 first returns a reply message NXDOMAIN (AAAA) to an AAAA query (SQ5), and then returns an A reply showing an IPv4 address corresponding to the enquiry host name as the reply message to an A query (SQ4).

When the DNS proxy server 10 receives NXDOMAIN from the DNS contents server 30 (SQ5), it starts a T3 timer (S13), and waits for a reply message to the A query while retaining NXDOMAIN in the server without forwarding it to the terminal 1. When a time T3 has elapsed from the start, the T3 timer times out. The value of the time T3 is computed from a first order relation (T3=β.T1) of T1 which is set up beforehand according to the value of the time T1 from when the A query is transmitted to when the first reply (in this example, NXDOMAINA) is delivered. Here, β is a coefficient having an integer part and a decimal part, and β can be equal to α.

If an A reply showing an IPv4 address corresponding to the specified host name is transmitted before the T3 timer times out (SQ4), the DNS proxy server 10 determines that NXDOMAIN received in the step SQ5 was issued mistakenly, generates a DNS reply message AAAA reply (No address) of IPv6 showing that there is no IPv6 address in the enquiry host name based on the contents of the A reply (S14), and transmits it to the requesting terminal 1 (SQ10). The following sequence SQ21-SQ24 is identical to that of FIG. 2.

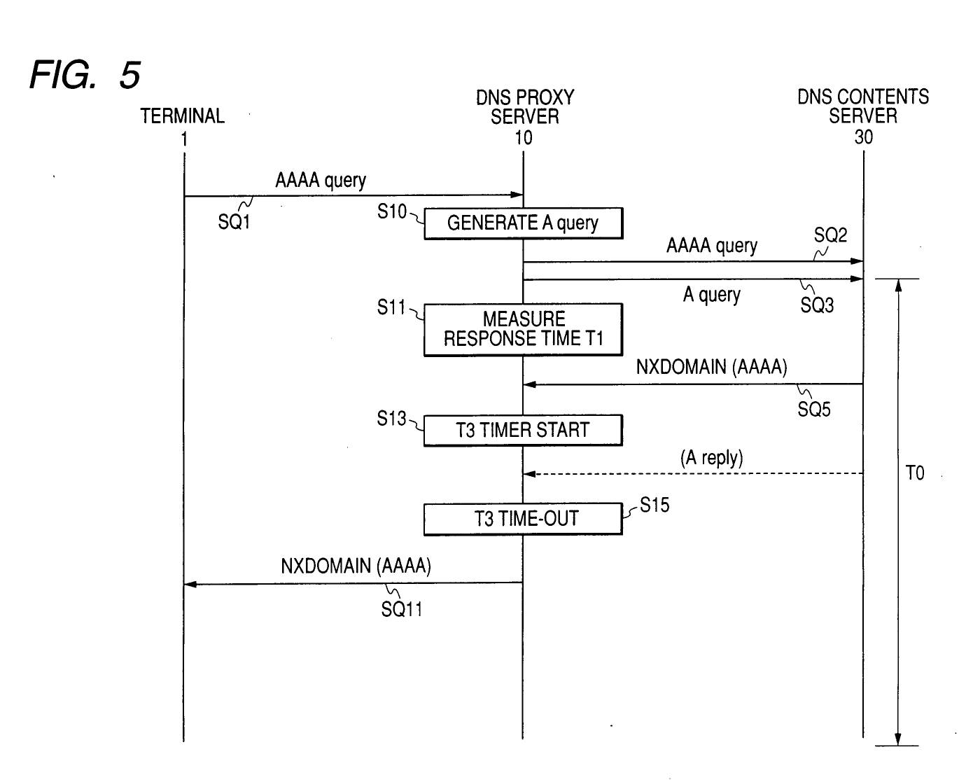

FIG. 5 shows a communications sequence where, in the sequence of FIG. 4, after the DNS proxy server has received NXDOMAIN (SQ5), the T3 timer times out (S15) while waiting for a reply to the A query.

In this case, the DNS proxy server 10 forwards NXDOMAIN which was waiting for transmission to the terminal 1 (SQ11). The terminal 1, by receiving the aforesaid NXDOMAIN, determines that the host name specified by the AAAA query does not exist in the Internet, and interrupts communication with the host.

FIG. 6 shows the packet format of a DNS message.

A DNS message M such as an AAAA query, A query, AAAA reply, NXDOMAIN or A reply is transmitted in the form of an IP packet having an IP header H1 and a TCP/UDP header H2.

FIG. 7 shows the message format of an AAAA query issued by the terminal 1.

An AAAA query 60, as shown in FIG. 7, has a header part H6 and an enquiry part Q6, and the header part H6 contains a message ID 61 and another header information part 62. The enquiry part Q6 includes a domain name (QNAME) 63 showing a host name whose address is being searched, an enquiry type (QTYPE) 64 showing whether the address being searched is IPv6 or IPv4, and an enquiry class (QCLASS) 65.

For example, the AAAA query 60 issued by the terminal 1 to acquire the IPv6 address of the host 2 shown in FIG. 1 includes the host name “host.example.co.jp” as the QNAME 63, and a value “28” showing that this is an IPv6 host name resolution message as the QTYPE 64.

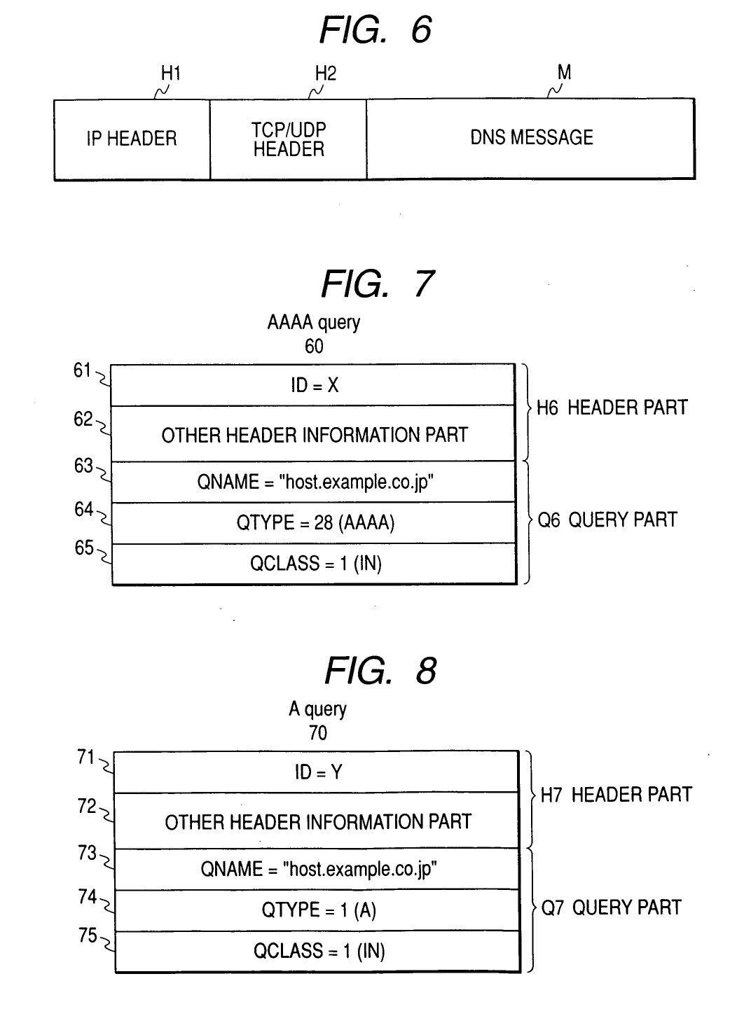

FIG. 8 shows the message format of an A query generated by the DNS proxy server 10. An A query 70 has a header part H7 and an enquiry part Q7, and contains identical data items 71-75 to those of the AAAA query 60.

When the DNS proxy server 10 receives the AAAA query 60 from the terminal 1, it generates an A query containing an ID value different from that of the AAAA query as a message ID 71, and a value “1” showing that this is an IPv4 host name resolution message as the QTYPE 74. The same host name as that of the QNAME 63 of the AAAA query is set in the QNAME 73.

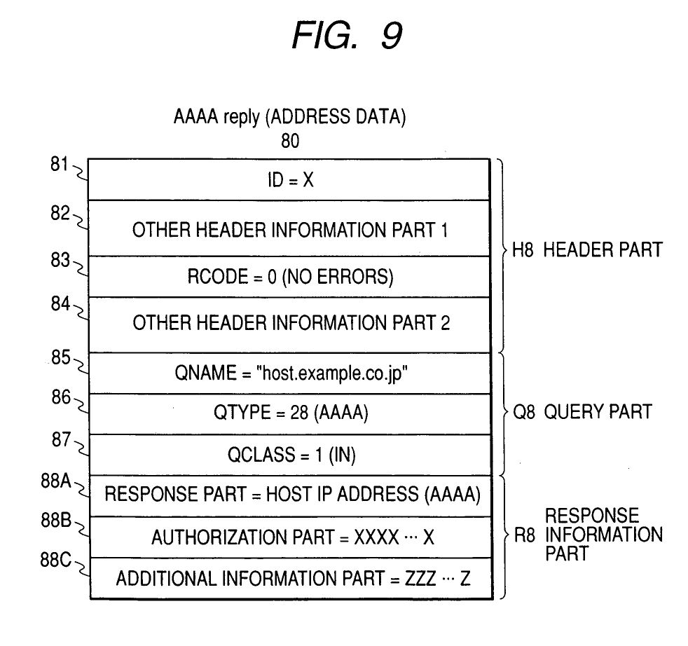

FIG. 9 shows the message format of an AAAA reply issued by the DNS contents server 30. An AAAA reply 80 has a header part H8, an enquiry part Q8 and a reply data part R8.

The header part H8 has a message ID 81, RCODE 83, and other header information 82, 84. The enquiry part Q8 includes data items 85-87 identical to those of the AAAA query 60, and the reply data part R8 includes a reply part 88A, authorization part 88B and additional information part 88C.

The same ID value as that of the AAAA query 60 is set as the message ID 81, and the same values as the QNAME 63, QTYPE 64, QCLASS 65 of the AAAA query 60 are respectively set in the QNAME 85, QTYPE 86, QCLASS 87 of the enquiry part Q8. The RCODE 83 shows whether or not there is an error in the resolution processing executed by the DNS contents server 30.

In the case of NXDOMAIN, “3” is set as the RCODE 83, and the reply part 88A, authorization part 88B and additional information part 88C are respectively blank. If the search for IPv6 address data is successful, “0” showing there is no error is set as the RCODE 83, and the value of the IPv6 address of the host is set as the reply part 88A. The values of the authorization part 88B and additional information part 88C are set according to the situation of the DNS contents server 30.

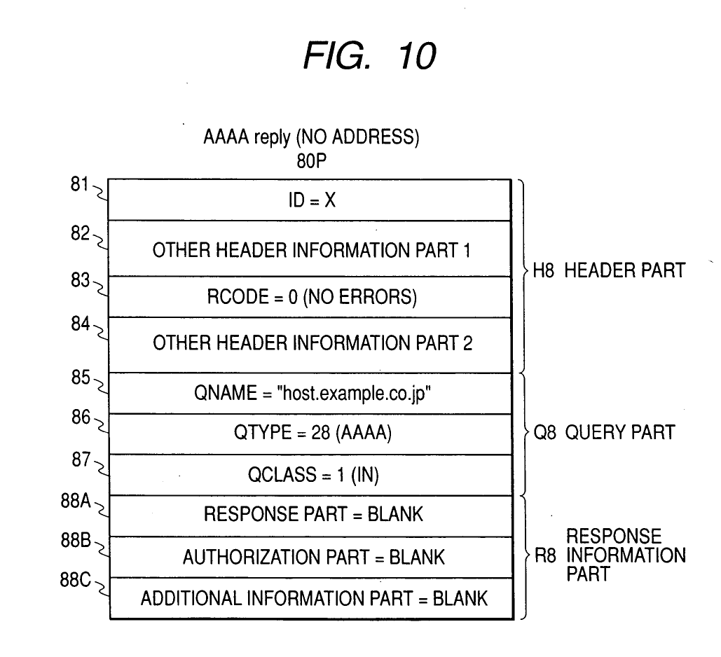

FIG. 10 shows the message format of an AAAA reply (No address) 80P generated by the DNS proxy server 10.

The AAAA reply (No address) 80P has an identical format to that of the AAAA reply 80 issued by the DNS contents server 30, an identical ID value to that of the AAAA query 60 is set as the message ID 81, and “0” showing no error is set as the RCODE 83.

Identical values to the QNAME 63, QTYPE 64, QCLASS 65 are respectively set as the QNAME 85, QTYPE 86, QCLASS 87, and the reply part 88A, authorization part 88B and additional information part 88C are respectively blank.

The A reply issued by the DNS contents server 30 in response to the A query 70 shown in FIG. 8 has an identical format to that of the AAAA reply 80 shown in FIG. 9, “1” indicating IPv4 is set as the QTYPE 86, and the IPv4 address value of the host is set as the reply part 88A. Also, the message ID of the A query 70 is set as the message ID 81.

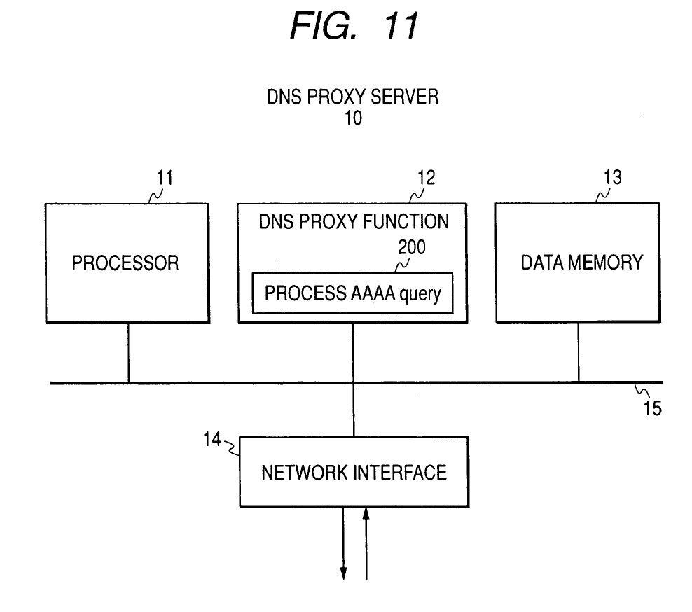

FIG. 11 shows one example of the construction of the DNS proxy server 10.

The DNS proxy server 10 includes a processor 11, program memory 12, data memory 13, network interface 14, and an internal bus 15 which interconnects these elements.

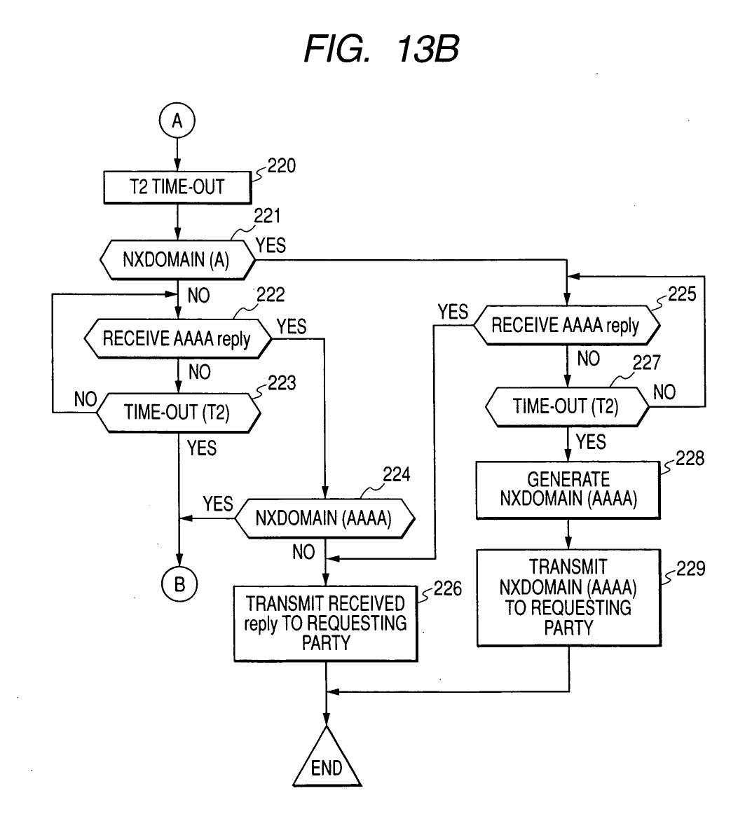

The program memory 12 stores various software executed by the processor in order to implement the functions of the DNS proxy server (or cache server). The DNS proxy server 10 of the invention has an improved AAAA query processing routine 200 described in detail in FIGS. 13A, 13B as part of its DNS proxy server functions.

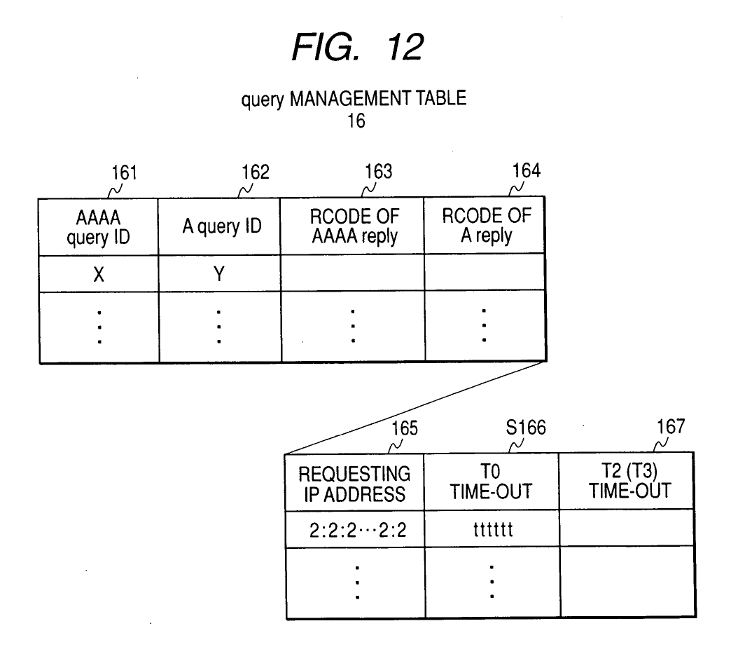

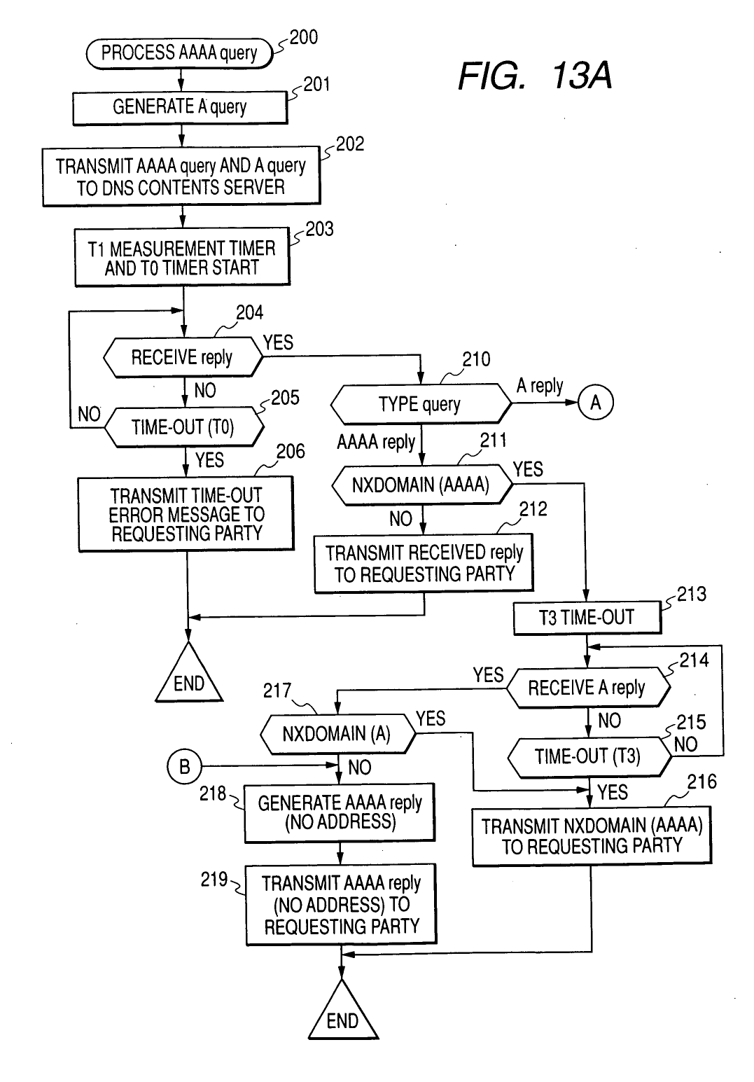

The data memory 13 stores various data required by the DNS proxy server. In the case of a DNS cache server, part of the data memory 13 is used as a cache memory. A query management table 16 described later in FIG. 12 is formed by the data memory 13.

FIG. 13A, 13B are flow charts showing one example of the AAAA query processing routine 200 executed by the processor 11.

As was mentioned in the description of FIG. 2, in actual application, the DNS proxy server 10, in order to specify the DNS contents server to which the query is transmitted, executes various processing such as a DNS tree search prior to transmitting queries, but since this processing is generally performed by a DNS proxy server anyway, it has been omitted from the flow charts to simplify the description. Also herein, in the case of a DNS cache server, the search processing of the cache memory executed when a query is received has been omitted.

Therefore, the AAAA query processing routine 200 shows the processing executed when, as a result of searching the cache memory, it is confirmed that address data corresponding to the enquiry request does not exist in the cache memory, and the DNS contents server to which the query is addressed has been specified by performing a DNS tree search.

The AAAA query processing routine 200 includes a request processor which is executed when an AAAA query is received, and a reply processor which is executed when a reply message is received from the DNS contents server.

When an AAAA query is received from the terminal 1, the processor 11 generates an A query having an identical enquiry domain name to that of the AAAA query with a different message ID (201), and transmits the AAAA query received from the terminal and the A query which it generated to the DNS contents server 30 (202). Next, the processor 11 starts a measurement timer of a predetermined time T1 until the first reply from the DNS contents server 30 is received, and a T0 timer which notifies timeout of a predetermined maximum latency time T0 (203), and waits for reception of a reply message from the DNS contents server 30 (204).

If the T0 timer times out without receiving an A reply or AAAA reply from the DNS contents server 30 (205), the processor 11 transmits a timeout error message to the requesting terminal 1 (206), and the routine is terminated.

When the first reply message is received from the DNS contents server 30, the processor 11 determines whether the received message is a reply message to an A query or a reply message to an AAAA query from the QTYPE of the received message (210). If the received message is a reply message (A reply) to an A query, the processor 11 executes processing of a step 220 and subsequent steps of FIG. 13B, described later.

If the received message is a reply message (AAAA reply) to an AAAA query, the processor 11 determines whether or not the received message is NXDOMAIN from the RCODE of the received message (211). If the received message is not NXDOMAIN, i.e., in the case of an ordinary AAAA reply showing IPv6 address data of the host or an AAAA reply showing that the enquiry host name does not have an IPv6 address, the processor 11 transmits the received message (AAAA reply) to the requesting terminal 1 (212), and the routine is terminated.

If the received message is NXDOMAIN, the processor 11 starts a T3 timer restricting the latency time of the reply message (A reply) to an A query while retaining NXDOMAIN in the memory (213), and waits for reception of an A reply (214). The set value of the T3 timer is determined according to the measurement value T1 of the T1 timer, and times out earlier than the T0 timer. If the T3 timer times out without having received an A reply (215), the processor 11 transmits NXDOMAIN which was retained in the memory to the requesting terminal 1 (216), and the routine is terminated. The transmission of NXDOMAIN corresponds to the step SQ11 of FIG. 5.

If a reply message to an A query is received before the T3 timer times out, the processor 11 determines whether or not the received message is NXDOMAIN from the RCODE of the received message (217). If the received message is NXDOMAIN, the processor 11 transmits NXDOMAIN which was retained in the memory to the requesting terminal 1 (216), and the routine is terminated.

If the received message was not NXDOMAIN, i.e., in the case of an ordinary A reply showing IPv4 address data of the host, the processor 11 generates an AAAA reply showing that the desired IPv6 address data does not exist based on the received A reply (218), transmits this to the requesting terminal 1 (219), and the routine is terminated. The generation of the AAAA reply corresponds to the step S14 of FIG. 4.

If the message received first is a reply message to an A query, the processor 11, as shown in FIG. 13, starts the T2 timer which restricts the latency time of the reply message (AAAA reply) to the AAAA query (220). The processor 11 checks the RCODE of the first received message (221), and if the RCODE is “0” (no error), i.e., if the received message is an A reply message showing the IPv4 address of the specified host, reception of the AAAA reply from the DNS contents server 30 is awaited (222).

If the T2 timer times out before an AAAA reply has been received (223), since the existence of the enquiry domain name in the Internet has already been confirmed by reception of a normal A reply message, the processor 11 executes the steps 218, 219 of FIG. 13A, transmits an AAAA reply showing that the desired IPv6 address does not exist to the requesting terminal 1, and the routine is terminated. The transmission of the AAAA reply corresponds to the step SQ10 of FIG. 3.

If an AAAA reply is received before the T2 timer times out, the processor 11 checks the RCODE of the received message (224). If the RCODE is an error code “3”, i.e., if the received message is NXDOMAIN, the processor 11 executes the steps 218, 219 of FIG. 13, transmits an AAAA reply showing that the desired IPv6 address does not exist to the requesting terminal 1, and the routine is terminated. If the RCODE of the received message is “0” (no error), the processor 11 transmits the received message (AAAA reply showing the desired IPv6 address) to the requesting terminal 1 (226), and the routine is terminated. The transmission of the AAAA reply corresponds to the step SQ9 shown by the dotted line of FIG. 3.

If the RCODE of the A reply message which was received first is a value showing an error, i.e., if the received message is NXDOMAIN of IPv4 (221), the processor 11 waits for reception of an AAAA reply from the DNS contents server 30 (225). If the AAAA reply is received before the T2 timer times out, the processor 11 transmits the received message to the requesting terminal 1 (226), and the routine is terminated.

If the T2 timer times out before an AAAA reply is received (227), since it has already been confirmed that the specified domain name does not exist in the Internet due to reception of the NXDOMAIN of IPv4, the processor 11 generates a NXDOMAIN of IPv6 showing that the specified host name does not exist in the Internet (228), this is transmitted to the requesting terminal 1 (229), and the routine is terminated.

The aforesaid AAAA query processing routine 200 focuses on one AAAA query, and shows the processing executed by the processor 11 of the DNS proxy server 10 as a time series. However, in actual application, the DNS proxy server 10 receives AAAA queries from plural terminals, and also receives plural AAAA replies and A replies having different message IDs one after another from the DNS contents server. Therefore, the processor 11 has to manage the reply reception status from the DNS contents server for each generated AAAA query, and control the transmission of reply messages to each terminal.

FIG. 12 shows an example of the A query management table 16 which the processor 11 looks up in order to control transmission of reply messages to the terminals.

The query management table 16 includes plural table entries 160-1, . . . corresponding to AAAA queries. Each table entry shows an AAAA query ID 161, A query ID 162, AAAA reply RCODE 163, A reply RCODE 164, requesting IP address 165, T0 timeout 166, and T2 (T3) timeout 167.

When the processor 11 receives an AAAA query, it generates an A query having the same enquiry domain name, and adds a new table entry 160-j for the AAAA query to the query management table 16. At this point, when the RCODE 164, 165 and the T2 (T3) timeout 167 of the data entry 160-j, are blank, the value of the message ID 81 of the received AAAA query is set as the AAAA query ID 161, the message ID 71 of the generated A query is set as the A query ID 62, and the value of the destination IP address extracted from the IP header H1 of the received AAAA query is set as the requesting IP address 165. Also, the timeout time of the T0 timer is set as the T0 timeout 166.

The processor 11, each time a reply message is received from the DNS contents server, looks up a table entry 160-k corresponding to the message ID of the received message from the query management table 16, and performs operations according to the status of the table entry.

When a reply message is received from the DNS contents server, if the columns for RCODE 164, 165 are both empty, the processor 11 may store the value of the RCODE of the received message in RCODE 164 or 165 of the aforesaid table entry 160-k, execute the steps 210-213 or 220 of the AAAA query processing routine 200, and in the step 213 or 220, compute the time out time of the T2 or T3 timer, and store this as the timeout time of the T2 (T3) timeout 165 in the aforesaid table entry.

When a reply message is received from the DNS contents server, if valid data has already been stored in one of the RCODE 164 and 165, the processor 11 determines whether the received message is an AAAA reply or an A reply from the QTYPE of the received message. If the received message is an A reply, the processor 11 may execute the steps 216-219 of the AAAA query processing table 200, and if the received message is an AAAA reply, it may execute the steps 222, 224-226 of the AAAA query processing routine 200 according to the status of the A reply shown by the RCODE 164 or 165.

The processor 11 also regularly checks the timeout times shown by the timers 166, 167 of the query management table 16, and with regard to table entries when the timeout times have been reached, selectively executes the steps 206, 216, 218-219 or 228-229 of the AAAA query processing routine 200 according to the status of the RCODE 164 and 165. When a reply message is transmitted to the requesting terminal in the steps 212, 216, 219, 226 or 229, unnecessary table entries may be deleted from the query management table 16.

What is claimed is:

1. A DNS proxy server which exchanges a DNS message with a terminal, comprising:
a request processor which, when a DNS enquiry message AAAA request of IPv6 is received from the terminal, generates a DNS enquiry message A request of IPv4 with the same enquiry domain name as this enquiry message, and transmits said AAAA request and A request to a specific DNS contents server in the Internet; and
a reply processor which, when NXDOMAIN showing that the enquiry domain name is an error, is received from said DNS contents server, generates, as the DNS reply message of IPv6 to said AAAA request, a different DNS reply message from said NXDOMAIN according to the details of the DNS reply message of IPv4 to said A request received from said DNS contents server, and transmits it to said terminal.

2. The DNS proxy server according to claim 1,
wherein, when an A reply showing an IPv4 address corresponding to the aforesaid enquiry domain name is received as the DNS reply message of IPv4, said reply processor generates, as the DNS reply message of IPv6 to the AAAA request, a message AAAA reply showing that there is no IPv6 address in said enquiry domain name, and transmits it to said terminal.

3. The DNS proxy server according to claim 2,
wherein when said NXDOMAIN is received prior to said DNS reply message of IPv4 from said DNS contents server, said reply processor waits for reception of the DNS reply message of IPv4 from said DNS contents server while retaining said NXDOMAIN.

4. The DNS proxy server according to claim 3,
wherein, when said NXDOMAIN is received, said reply processor starts a timer for restricting the latency time of the DNS reply message of IPv4, and when the timer has timed out without receiving the DNS reply message of IPv4, transmits said NXDOMAIN to said terminal.

5. The DNS proxy server according to claim 4,
wherein, when the AAAA request or A request is transmitted, said request processor starts a timer for measuring the response time of said DNS contents server is started, and when said NXDOMAIN is received, said reply processor determines the latency time of said DNS reply message of IPv4 according to the response time shown by said measurement timer.

6. The DNS proxy server according to claim 2,
wherein, when said A reply is received prior to the DNS reply message of IPv6 from said DNS contents server, said reply processor starts a timer for restricting the DNS reply message latency time of IPv6, and if said NXDOMAIN is received before this timer times out, generates a message AAAA reply showing that there is no IPv6 address in said enquiry domain name, and transmits it to said terminal.

7. The DNS proxy server according to claim 2,
wherein, when said A reply is received prior to the DNS reply message of IPv6 from said DNS contents server, said reply processor starts a timer for restricting the DNS reply message latency time of IPv6, and if said timer times out without receiving the DNS reply message of IPv6, generates a message AAAA reply showing that there is no IPv6 address in said enquiry domain name, and transmits it to said terminal.

8. The DNS proxy server according to claim 6,
wherein when the AAAA request or A request is transmitted, said request processor starts a timer for measuring the response time of said DNS contents server, and when said A reply is received, said reply processor determines the latency time of said DNS reply message of IPv6 according to the response time shown by said measurement timer.

9. The DNS proxy server according to claim 1,
wherein, when the AAAA request or A request is transmitted, said request processor starts a timer for measuring the response time of said DNS contents server, and when the timer for said response-time measurement reaches a predetermined timeout time without receiving a DNS reply message of IPv6 or a DNS reply message of IPv4 from said DNS contents server, said reply processor generates, as the DNS reply message of IPv6, NXDOMAIN showing that the enquiry domain name of said AAAA request is an error, and transmits it to said terminal.

10. The DNS proxy server according to claim 1,
wherein, when an AAAA reply showing said enquiry domain name and a corresponding IPv6 address is received from said DNS contents server as the DNS reply message of IPv6 to said AAAA request, said reply processor transmits this AAAA reply to said terminal.

11. The DNS proxy server according to claim 1, comprising:
a cache memory which stores a relation between an enquiry domain name and an IP address shown by an AAAA reply and an A reply received from the DNS contents server,
wherein, when the AAAA request or A request is received from the terminal, said request processor looks up said cache memory, and if there is an IP address corresponding to the enquiry domain name shown by said received request in the cache memory, generates a DNS reply message showing this IP address, and transmits it to the requesting terminal.
